(19) United States
(12) Patent Application Publication
(10) Pub. No.: US 2006/0047775 A1
(43) Pub. Date: Mar. 2, 2006

(54) Method and apparatus for downloading content

(76) Inventors: Timo Bruck, Mountain View, CA (US); Victor Wong, Newark, CA (US); Thomas R. Hammer, San Mateo, CA (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/928,451

(22) Filed: Aug. 27, 2004

(51) Int. Cl. G06F 15/16

(52) U.S. Cl. 709/217

(57) ABSTRACT

Methods and apparatus for managing download of content to a client device are disclosed. In one aspect, the download process is optimized for bandwidth usage by using criteria such as time of day, level of network activity and priority of download. In another aspect, download of content is prioritized based on certain rules, user inputs and pre-emptive events on the client device. A computer program embodying these methods and a multimedia client device adapted to run this program are also disclosed.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of Invention

The invention relates generally to the field of video on demand (VOD). In one exemplary aspect, the invention relates to the design of a computer-implemented method used to fetch multimedia content from network resources by a client device.

2. Description of Related Technology

Traditional distribution channels for audio-video content use a broadcast model for the distribution of services. For example, in Direct-To-Home (DTH) satellite and coaxial cable networks, a program lineup is transmitted over the network from a single source (satellite uplink or cable head-end) to multiple client devices. Based on the selection made by the content viewer, the client device is tuned to the appropriate channel or packet stream within a channel and the desired program is received.

With the recent advances in computer and telecommunication technologies, a different distribution model, namely VOD, has emerged as a popular method for content distribution.

Video on Demand Services

VOD generally refers to a personalized viewing service offered by a content provider or a network operator to a content viewer. The viewer is able to start a VOD session by electronically browsing through a catalog of available content, selecting a program for viewing and receiving the selected content for viewing almost instantly over the network to the client device.

A client device is provided to receive encrypted programs, decode, and produce audio-video signals suitable for viewing the program on a computer or television monitor. The client device also provides mechanisms (e.g., jitter removal, duplicate packet removal, etc.) to overcome imperfections of network transmission to preserve the real time nature of the content.

VOD sessions are typically unicast. To maintain Quality of Service of a session, some network resources (such as bandwidth, Internet Protocol (IP) address, etc.) have to be reserved for the duration of the viewing exclusively for one content viewer. An example high-level block diagram of a conventional VOD network is shown in FIG. 1. A client device 100 is connected to a near-end server called an edge server 104 through a network connection 102. The network connection 102 is typically called an “access network” and provides connectivity between the client device and the server via IP (e.g. DOCSIS or DSL connection) or other transport protocols (e.g. digital cable, Digital Audio Video Council (DAVIC) etc.) The entire VOD content in general may not be available at the edge server 104, but could be located on one or more content servers 116 at a different location. The connection between content server 116 and edge server 104 is made via an intermediate network 110 which could be, for example, the Internet, or a private network or a Storage Area Network (SAN) and so on. When the content is flowing from content server 116 to a client device 100 during a VOD session, the appropriate resources have to be allocated for transfer of the content over the intermediate networks, links (102,108, 118) and servers. Such real time and/or high bandwidth data transfer of VOD content lends itself to expensive network and server equipment. Moreover, network designers must design networks to take into account peak bandwidth requirements (as concurrent VOD sessions from multiple client devices connected over network link 102 to the edge server 104 have an additive effect on the network resource requirement), when in fact actual VOD usage is known to be non-uniform in time. Consequently, much of a VOD network's resources are underutilized most of the time.

Personal Video Recorders (PVR)

PVR technology has become popular and ubiquitous in the last few years. While VOD service allows personalized control over what to watch by allowing a content viewer to choose a program to watch, PVRs allow personalized control over the program in the form of “trick modes” (e.g. pause, rewind, fast forward) while watching it as well as providing “time shifting” (watch a program when you want, not just when broadcast) capabilities.

In a limited sense, PVRs offer VOD capability for content that was previously broadcast to, and locally stored by, the client device. It is not surprising that the general functional components of a PVR client device are similar to those of a VOD client device. FIG. 2 shows a high-level block diagram that describes both a VOD client device and a PVR device 202. The three major functional subsystems are—Content Acquisition Subsystem 204 (including interfaces to various networks, demodulator, descrambler, PID filters, IP filters etc.), Content Storage Subsystem 206 (including hard drive(s), other types of storage media, software that controls storage and erasure of media, etc.) and Content Processing/Presentation Subsystem 212 that provides functions such as video and audio decompression, synchronization, de-jitter, decryption, format conversion, and so on. The Content Acquisition Subsystem is connected to network 200 by a possibly bi-directional connection. The User Interface and Control function 208 is used to accept user inputs and convey them to the central processor 210, which typically executes software to control the operation of the other functional units of PVR 202.

Both PVR and VOD services and client devices that are currently deployed lack several desirable features. For example, VOD content available to a user is limited to titles made available by the network operator through the operator's business arrangements with the content providers. Similarly, network infrastructure costs to accommodate peak usage statistics of VOD are significant. The selection of available content on a PVR is limited to that being broadcast currently or content previously stored on the PVR storage subsystem.

Client Software Based Content Download

Internet infrastructure historically used for delivery of data is increasingly being used for delivery of audio, video and other multimedia programs. Recently, some content providers (e.g. MovieLink™ and CinemaNow™) have begun offering services that combine some desirable elements of VOD service and PVRs by using the Internet as the means of transferring content to a personal computer. In the VOD aspect, these services allow a content viewer to choose from a selection of movie titles, music videos, etc. In the PVR aspect, the copyrights associated with the content typically allow a viewer to download and store the content on a local storage device and watch the content multiple times (including the ability to pause, rewind and fast forward) within an authorized time window.

Despite advances, several desirable features are still lacking. For example, each of the above-described devices and services are limited to working with a dedicated content list and client/server interaction to offer VOD and fall short of a true “Internet browsing” experience wherein a user can direct his browser to any resource location on the network and in a few simple clicks get the content sent from that location to his client device. Similarly, there is pent up demand to be able to access niche content such as ethnic programming, regional news and sports, instructional videos and so on, that is not satisfied by any of the conventional content delivery methods described above.

Availability of Network Bandwidth

The amount of data required for download in order to watch movies or video/audio clips can be significant. For example, a DVD-quality movie compressed using MPEG-2 can be about 4 Gigabytes in size. At currently available network transfer rates this volume of data puts significant stress on both edge networks and core networks. It is therefore beneficial for both content viewers and content providers to make use of the available infrastructure efficiently. Between the dedicated client model of VOD and PVR on one side of the spectrum and the Internet browser model of content download on the other side, there is a lack of adaptable bandwidth usage mechanisms whereby the content viewer can make smart decisions about what content to download to his device, from where to fetch it, when to get it, and how to get it.

Specifically in the context of a home environment, using an nternet connection to download content for viewing produces resource competition with other home devices such as workstations needing to use the same network bandwidth. What is needed is a method for avoiding the situation in which competing download operations create resource scarcities due to sharing of an “access network” connection.

Another limitation of conventional client devices is the inability to throttle or pre-empt bandwidth of lower priority downloads in favor of higher priority downloads by periodically monitoring priorities of all outstanding downloads.

Based on the foregoing, it will be evident that while the prior art has in general recognized the utility of client devices that download content to the content owner's liking, it lacks a method to adequately address many of the problems and intricacies associated with using this approach. Specifically, the conventional methods do not offer a unified downloader function running on a client device that can be used to prioritize and manage content download based on user-selected criteria and network availability.

What is needed are flexible methods and apparatus that make use of the download criteria described above. Such improved methods and apparatus ideally should be able to operate on multiple network interfaces simultaneously.

### SUMMARY OF THE INVENTION

The present invention addresses the foregoing needs by providing, in various embodiments, a method and apparatus for managing content downloads to a client device. In one embodiment, the present invention provides a computer-implemented method for automatically downloading Internet content at a time and from a source chosen according to content viewer-defined selections and content provider-defined resource availability criteria. The content provider-defined resource availability criteria may include a time windows during which the Internet content can be downloaded from a specified host. The Internet content may be downloaded according to whether or not a content viewer-defined timer is in a state that permits said downloading and/or whether or not other network devices are making use of network bandwidth over which the downloading will occur. In the latter case, an indication of whether or not other network devices are making use of network bandwidth over which the downloading will occur may be determined by the state of screensavers associated with the other network devices.

The downloading of the Internet content preferably (though not necessarily) takes into account priorities of the content viewer-defined selections. Thus, prior to downloading the Internet content, a target host having favorable content provider-defined resource availability criteria may be selected from a prioritized list of the content viewer defined selections. The favorable content provider-defined resource availability criteria may include a time window during which the Internet content can be downloaded that includes a current time.

The automatic downloading may, in some cases, be performed at a time when other computer resources are not using network bandwidth over which the downloading will be performed. Further, the automatic downloading may be performed such that higher priority content viewer-defined selections are permitted to preempt downloads of lower priority content viewer-defined selections, even, in some cases, during downloads of the lower priority content viewer-defined selections. The downloading may, in any of the foregoing examples, be performed over multiple channels.

A further embodiment of the present invention provides a computer-implemented method in which a first of a number of content viewer-defined selections of Internet content to be downloaded to a computer readable medium is chosen from a work list made up of such selections according to (i) its priority, and (ii) availability criteria for a corresponding host from which it can be downloaded. In most cases, at least a portion of the content associated with the content viewer-defined selection may be downloaded if a content viewer-defined timer is in a state that permits same.

In some cases, the downloading may be preempted in favor of content associated with higher priority content viewer-defined selections, or may be stopped altogether in response to an indication that another network device requires access to network bandwidth being used for such downloading. Such an indication may include the setting of a timer and/or an indication that a screensaver associated with the network device is no longer active.

Another embodiment of the present invention provides a video-on-demand system that includes a content acquisition system configured to automatically download Internet content at a time and from a source chosen according to content viewer-defined selections and content provider-defined resource availability criteria; and a content storage system configured to store said Internet content so downloaded.

### BRIEF DESCRIPTION OF THE DRAWINGS

The above and other features and advantages of the present invention are hereinafter described in the following detailed description of illustrative embodiments to be read in conjunction with the accompanying drawings and figures, wherein like reference numerals are used to identify the same or similar system parts and/or method steps, and in which:

FIG. 1 illustrates a high-level block diagram of a VOD network.

FIG. 2 illustrates a functional block diagram of a device that could either be a VOD client or a PVR client or both.

FIG. 3 shows an example of a work list used to manage content downloads in accordance with one embodiment of the present invention.

FIG. 4 shows an example of a list of provider windows used to manage content downloads in accordance with one embodiment of the invention.

FIG. 5 shows an example of a computer-implemented process used to perform content downloads in accordance with one embodiment of the present invention.

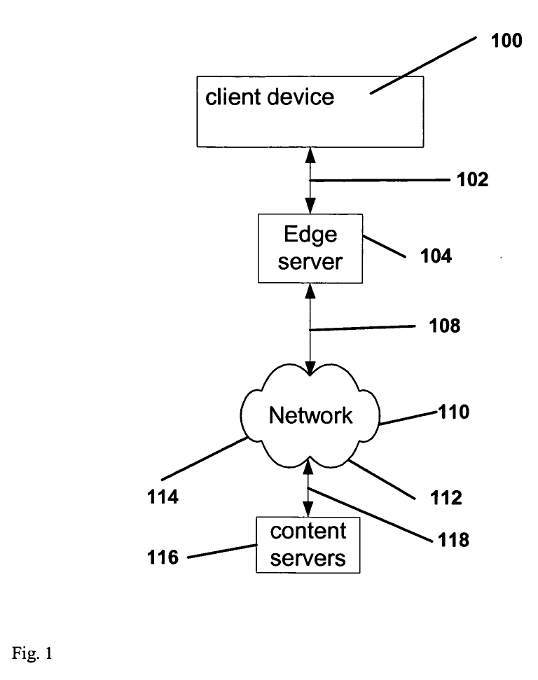

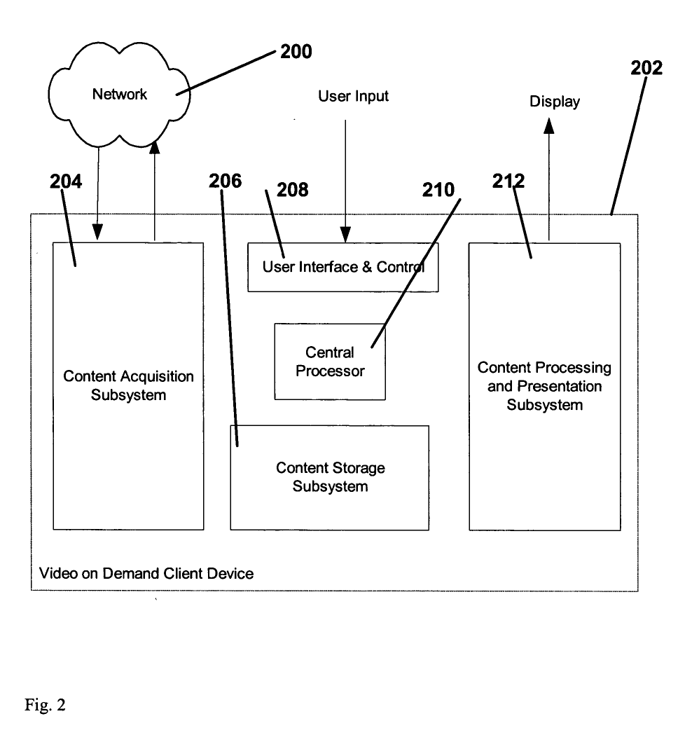

### DETAILED DESCRIPTION

Reference is now made to the drawings wherein like numerals refer to like parts throughout. Described herein are improved methods and apparatus for downloading media to a personal video client device. The present invention overcomes the limitations of above-described systems, in part by providing a software module to manage downloads of content from various sources. In one embodiment, a computer program adapted to run on a computer system to perform the download process in a highly efficient and robust fashion includes the fetcher routine described below to manage content download.

As used herein, the term “VOD” is meant to include on-demand delivery of audio, video, graphical, software, computer games, etc.

As used herein, the term “operator” is meant to refer to an entity, other than a home or end-user, involved in manufacturing, design, deployment or maintenance of a system embodying the present invention, including but not limited to a cable system operator, satellite provider, DSL internet provider, content provider, client device manufacturer, as appropriate.

As used herein, the term “content” refers to audio, video, graphics files (in uncompressed or compressed format), icons, software, text files and scripts, data, binary files and other computer-usable data used to operate a client device and produce desired audio-visual effects on a client device for the viewer.

As used herein, the terms “computer method,” “computer program”, “routine,” and “subroutine” are substantially synonymous, with “computer method” being used typically (but not exclusively) to describe collections or groups of the latter two elements. Such programs and routines/subroutines may be rendered in any language including, without limitation, C#, C/C++, Fortran, COBOL, PASCAL, assembly language, markup languages (e.g., HTML, SGML, XML, VOXML), and the like, as well as object-oriented environments such as the Common Object Request Broker Architecture (CORBA), Java™ and the like. In general, however, all of the aforementioned terms as used herein are meant to encompass any series of logical steps performed in a sequence to accomplish a given purpose.

In view of the above, it should be appreciated that some portions of the detailed description that follows are presented in terms of algorithms and symbolic representations of operations on data within a computer memory. These algorithmic descriptions and representations are the means used by those skilled in the computer science arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like. It should be borne in mind, however, that all of these and similar terms are to be associated with the appropriate physical quantities and are merely convenient labels applied to these quantities. Unless specifically stated otherwise, it will be appreciated that throughout the description of the present invention, use of terms such as “processing”, “computing”, “calculating”, “determining”, “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention can be implemented with an apparatus to perform the operations described herein. This apparatus may be specially constructed for the required purposes, or it may comprise a general-purpose computer, selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and processes presented herein are not inherently related to any particular computer or other apparatus. Various general-purpose systems may be used with programs in accordance with the teachings herein, or it may prove convenient to construct more specialized apparatus to perform the required method. For example, any of the methods according to the present invention can be implemented in hard-wired circuitry, by programming a general-purpose processor or by any combination of hardware and software. One of ordinary skill in the art will immediately appreciate that the invention can be practiced with computer system configurations other than those described below, including hand-held devices, multiprocessor systems, microprocessor-based or programmable consumer electronics, DSP devices, network PCs, minicomputers, mainframe computers, and the like. The invention can also be practiced in distributed computing environments where tasks are performed by remote processing devices that are linked through a communications network. The required structure for a variety of these systems will appear from the description below.

The methods of the present invention may be implemented using computer software. If written in a programming language conforming to a recognized standard, sequences of instructions designed to implement the methods can be compiled for execution on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, application, etc.), as taking an action or causing a result. Such expressions are merely a shorthand way of saying that execution of the software by a computer causes the processor of the computer to perform an action or produce a result.

Overview

Fetcher

The Fetcher is a computer program that runs on a client device and manages content downloads. It will be appreciated by a person skilled in the art that whether Fetcher is run as a thread, application or process depends on the operating system and software configuration of the host platform. The Fetcher provides a level of abstraction between other processes and applications requesting content downloads from remote resources (e.g., Internet-accessible resources) and the details of network protocols, download priorities, and so on.

The Fetcher optimizes content downloads by using a plurality of book-keeping techniques. For example, in one embodiment described here, the Fetcher uses the following techniques to optimize content downloads: 1) a Work List for all pending and scheduled downloads, and 2) a Provider Window list that includes information about resource locations from which content may be accessed and time and priority rules associated with these locations. Both these techniques are described in further detail below. Several other embodiments are possible, including, for example having the content server providing real-time feedback to the Fetcher or the Fetcher noticing download is slow and backing off automatically, among others).

Work List

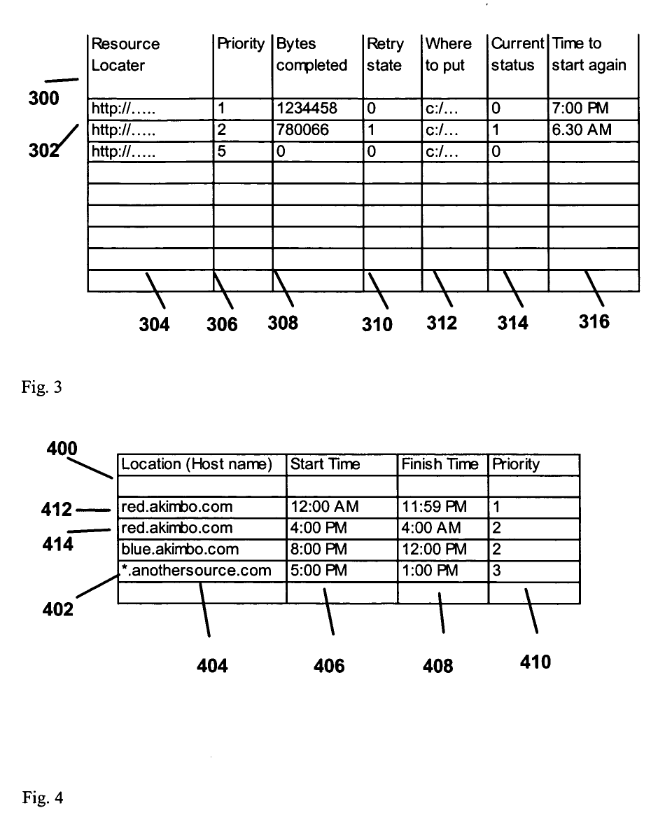

The Work List is logically organized in the form of a table. FIG. 3 shows an example of such a Work List configured in accordance with an embodiment of the present invention. Each individual download task is listed as a row entry of the table (for example row 302). The header row 300 of the table shows various parameters maintained per entry. The first column 304 lists resource locators (e.g., Web or other network addresses) from which the associated content is to be downloaded. The resource locater information is important so that the Fetcher can determine whether or not the Provider Window allows a download from that particular server and, if so, at what priority. The Fetcher may therefore make a choice regarding geographic location of the server from which to download content, based on the current time and permitted download times in the Provider Window list. The second column 306 indicates a priority associated with the table entry. Priority might be selected by the application requesting a download or by a pre-selected user or operator criteria. The third column 308 contains a current state of completion for the download entry. In the illustrated example the current state is indicated by the number of bytes already downloaded, however, many other forms of state information may be maintained in addition to or in lieu of this byte information. For example, percentage completion is a common form of state information that is maintained and/or displayed during a download of content from the Internet. The fourth column 310 indicates number of retries (if any) performed during the download of this entry. The fifth column 312 indicates where on the local storage media the content is to be stored. The sixth column 314 contains on/off information about the current status of this download. The seventh column 316 contains information about when next to start this download.

New requests are added to the Work List by the requesting entity (e.g., another software module). The Fetcher removes fulfilled requests from the Work List. It should be remembered that this form of the Work List is merely an example of same and that the particular configuration and/or layout of the Work List is not critical to the present invention. Instead, it is the functionality afforded by the Work List, which, as described further below, provides the advantages of the present invention and so other, similar table sand/or collections of parameters that afford similar functionality should be appreciated as being contemplated within the scope of the present invention.

Provider Window

The Provider Window list, shown via example in FIG. 4, provides another mechanism for input to the Fetcher to allow for the efficient management of content downloads. Each row in the Provider Window list has the following entries (indicated by column headers of row 400): a network location or host name, a Start time for the window, a stop time for the window and a priority associated with download that will take place during the designated time window. For example, as shown in row 402, downloads occurring from any server in the top level domain name “anothersource.com” that have a download priority of 3 (or greater) can only occur between the times of 5 PM and 1 AM. While FIG. 4 shows the timings in local time format, it is used so only for illustrative purpose. In another embodiment, time may be stored in another format such as Universal Time Clock (UTC) format. It should be noted that for a network address (domain name) multiple entries, each corresponding to a different priority level, could be added to the table with possibly overlapping time windows. This is illustrated in FIG. 4 by two rows 412 and 414 corresponding to the same content server red.akimbo.com.

The Provider Window list can be generated by several sources including but not limited to user inputs, operator settings, application requests and self-training by the Fetcher.

Priority Based Download

In a typical usage scenario, based on the user's viewing habits and selections, the client device will have several download tasks queued up, each of which will likely have a different degree of importance from the content viewer's perspective. To avoid resource contention, these download tasks can be prioritized using an appropriate priority scheme. In one embodiment, a number between 1 and 7 is used to indicate various priorities; with lower numbers representing higher priority downloads. The Fetcher can use priorities on a pre-emptive or non-preemptive basis, as per user or network input. For example, in one exemplary embodiment, the highest priority item on the Work List could signify a pre-emptive priority. This means that this item is downloaded as soon as any current pending requests for content download are fulfilled from content servers. Each download item can be assigned a priority by the content viewer, network operator, implementer of the present invention, or the content provider. The decision regarding what priority to assign can be based on several factors, including but not limited to, cost of bandwidth (e.g. dollars per bit), availability of high-speed connection, network quality assessment from errors and bandwidth encountered in a previous download from this location, etc.

Event Timer

In some cases, when the client device is sharing a connection to the access network, the user (or another application needing access to network bandwidth) may require unhindered access to the network. The Fetcher is notified of such a request by turning on an Event Timer with a specified duration or end time. For example, the Fetcher might be informed via the Event Timer that another process needs to pre-empt the Fetcher's downloads for the next 2 hours. Enabling the Event Timer will cause all items in the download queue to be paused for the requested amount of time in order to avoid bandwidth usage conflict, to balance network load or to optimize with respect to cost of transport.

Reverse Screensaver

The network bandwidth used by the Fetcher to download content from the network is typically shared with other networked devices within a content viewer's residence. A reverse screensaver process is provided between the Fetcher and other devices on a home network so that when a viewer is actively working with an application requiring network bandwidth (e.g., as indicated by the screensaver on the user's workstation or other device being off), the application does not suffer due to some bandwidth being taken away by a Fetcher-controlled download. When the viewer is away from the workstation (screensaver is turned on), and the Fetcher becomes aware of this fact, the Fetcher can continue its download processes. This reverse screensaver mechanism can be controlled by user selection of settings or by operator rules. The Event Timer described above and the Reverse Screensaver process can be used independently, or in conjunction with each other.

Protocols for Download

Since the Fetcher performs content download on behalf of other applications running on a client device, it provides an opportunity to simplify client software design by abstracting network and transport layer specific details from individual applications. It will also be appreciated that the Fetcher as described here is also adaptable to network and transport layer protocol details in a layered protocol stack implementation of client device software. When multiple network connections to content servers are available on a client device (e.g., DOCSIS and broadband wireless), the Fetcher simplifies the task of choosing the appropriate network for a given download.

### Description of Exemplary Embodiments

Exemplary embodiments of the method and apparatus of the present invention are now described in detail.

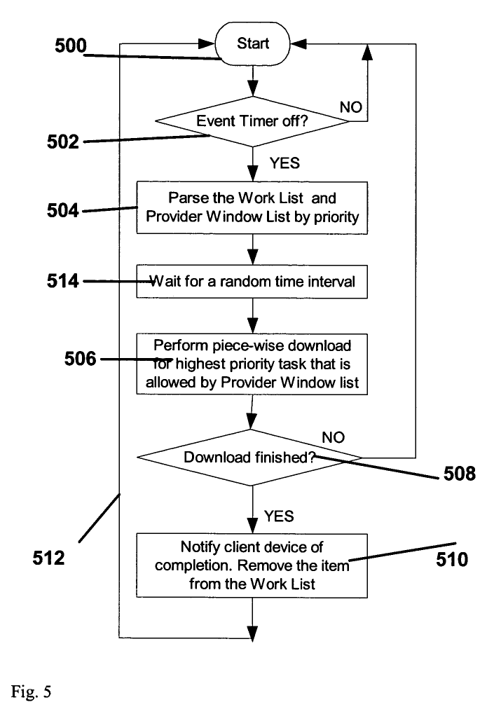

Referring to FIG. 5, the logic of execution followed by the Fetcher application is explained as below. Note that this illustration and the accompanying description are intended to set forth the sequence of logical operations involved in the Fetcher download process but that implementations of same may involve one or more optimizations which are not necessarily reflected in the diagram or description. These implementation details are not critical to the present invention but may afford commercial advantages. Because such implementation details are within the knowledge of those of ordinary skill in the art, however, they are not set forth in detail herein in order not to unnecessarily obscure the more important functional details regarding the operation of the Fetcher.

After the initial boot up, the Fetcher starts at 500 and checks to see if the Event Timer is in the OFF state (step 502). If the Event Timer is not OFF, it loops back to state 500 and waits for some amount of time before re-checking the Event Timer.

If the Event Timer is in OFF state, the Fetcher proceeds to parse the Work List and Provider Window list (step 504). At the end of the parsing process, the Fetcher determines the highest priority download task (step 506) and begins download. In an exemplary embodiment, the download is started after waiting for a random time (514). This step is introduced to ensure that a given content server does not get simultaneous download requests from multiple client devices; potentially leading to resource starvation; as soon as its Provider window “opens up.” An example text file is shown in Appendix I wherein the logical Work List and Provider Window list are combined into a simple text file. The text file shows entries for two content servers—red.akimbo.com and blue.akimbo.com. Based on the entries in this file, the Fetcher can derive the following download rules:
program1.wmv may be downloaded from red.akimbo.com at any time, or
program1.wmv may be downloaded from blue.akimbo.com between 20:00-24:00 UTC; and
program2.wmv may be downloaded from red.akimbo.com between 16:00-04:00 UTC, or
program2.wmv may be downloaded from blue.akimbo.com between 20:00-24:00 UTC.

Since the total amount of content (e.g., in bytes) requested per item on the Work List by the download task can be significant, the download in step 506 may be performed by dividing the content file into smaller pieces. Each download request specifies to the content server where within a file to start download from and how many bytes to transfer. The Hypertext Transfer Protocol (HTTP) supports such a download request and is used for downloading content. Since in a typical networking software stack, HTTP runs on top of the Transmission Control Protocol (TCP), error control and recovery mechanisms provided by TCP are used to ensure successful reception of requested bytes. A possible implementation also performs a checksum operation at the end of a download to verify successful reception of the entire content file.

Once the download of a content file is successful, the Fetcher moves to the next step (508) of to check if any more pieces of content on the current Work List are yet to be downloaded or if there are any errors in the checksum for the entire file. Upon completion of a successful download, the Fetcher removes the item from the Work List (510). If the download is deemed to be unfinished, the Fetcher slides back into the starting state 500.

Although one possible flow of logic is described above, it will be apparent to a person of ordinary skill in the art that many possible combinations of the above steps exist, each advantageous in some aspect. For example, if the Event Timer is checked every time a piece of content is downloaded, the time required for the Fetcher to respond to the Event Timer turning ON will be much faster. Similarly, the Fetcher could perform step 504 of prioritizing the Work List after every piece of the top priority download is successfully downloaded. This way, a lower priority download will be pre-empted midway through its piece-by-piece download if a higher priority download enters the Work List during that time. This allows for inclusion of a “Get it Now” feature for the user wherein download of content begins as soon as any outstanding download request from a client device to the network is completed.

Although the methods and apparatus of the present invention have been described with reference to Internet Protocol-based networks, it will be appreciated that the teachings are equally applicable to networks that use other transport protocols.

In the foregoing specification, the invention has been described with reference to specific exemplary embodiments thereof. It will, however, be evident to those of ordinary skill in the art that various modifications and changes may be made thereto without departing from the broader spirit and scope of the invention as set forth in the appended claims. The specification and drawings are, accordingly, to be regarded in an illustrative rather than a restrictive sense and that it is understood that the following claims including all equivalents are intended to define the scope of the invention.

What is claimed is:

1. A computer-implemented method, comprising automatically downloading Internet content at a time and from a source chosen according to content viewer-defined selections and content provider-defined resource availability criteria.

2. The computer implemented method of claim 1, wherein the content provider-defined resource availability criteria comprise time windows during which the Internet content can be downloaded from a specified host.

3. The computer-implemented method of claim 1, further comprising automatically downloading the Internet content according to whether or not a content viewer-defined timer is in a state that permits said downloading.

4. The computer-implemented method of claim 3, further comprising automatically downloading the Internet content according to whether or not other network devices are making use of network bandwidth over which said downloading will occur.

5. The computer-implemented method of claim 4, wherein an indication of whether or not other network devices are making use of network bandwidth over which said downloading will occur is determined by a state of screensavers associated with said other network devices.

6. The computer-implemented method of claim 1, wherein the downloading of the Internet content takes into account priorities of the content viewer-defined selections.

7. The method of claim 6, further comprising, prior to automatically downloading the Internet content, selecting from a prioritized list of the content viewer defined selections, a target host having favorable content provider-defined resource availability criteria.

8. The method of claim 7, wherein the favorable content provider-defined resource availability criteria comprises a time window during which the Internet content can be downloaded that includes a current time.

9. The method of claim 1, wherein the automatic downloading is performed at a time when other computer resources are not using network bandwidth over which said downloading will be performed.

10. The method of claim 1, wherein the automatic downloading is performed such that higher priority content viewer-defined selections are permitted to preempt downloads of lower priority content viewer-defined selections.

11. The method of claim 10, wherein the automatic downloading is performed such that higher priority content viewer-defined selections are permitted to preempt downloads of lower priority content viewer-defined selections even during said downloads of lower priority content viewer-defined selections.

12. The method of claim 1, wherein the downloading is performed over multiple network interfaces.

13. A computer-implemented method, comprising choosing, from a work list made up of content viewer-defined selections of Internet content to be downloaded to a computer readable medium, a first one of the content viewer-defined selections according to (i) a priority of said first one of the content viewer-defined selections, and (ii) availability criteria for a corresponding host from which said first one of the content viewer-defined selections can be downloaded.

14. The computer-implemented method of claim 13, further comprising downloading at least a portion of content associated with said first one of the content viewer-defined selections if a content viewer-defined timer is in a state that permits said downloading.

15. The computer-implemented method of claim 14, wherein said choosing is performed only if a content viewer-defined timer is in a state that permits said downloading.

16. The computer-implemented method of claim 14, further comprising preempting the downloading of content associated with said first one of the content viewer-defined selections in favor of downloading content associated with a second one of the content viewer-defined selections having a higher priority than said first one of the content viewer-defined selections.

17. The computer-implemented method of claim 14, further comprising stopping the downloading of content associated with said first one of the content viewer-defined selections in response to an indication that another network device requires access to network bandwidth being used for said downloading.

18. The computer-implemented method of claim 17, wherein the indication that another network device requires access to network bandwidth being used for said downloading comprises a setting of a timer.

19. The computer-implemented method of claim 17, wherein the indication that another network device requires access to network bandwidth being used for said downloading comprises an indication that a screensaver associated with said network device is no longer active.

20. A video-on-demand system comprising: a content acquisition system configured to automatically download Internet content at a time and from a source chosen according to content viewer-defined selections and content provider-defined resource availability criteria; and a content storage system configured to store said Internet content so downloaded.
